(19) United States
(12) Patent Application Publication
(10) Pub. No.: US 2020/0344946 A1
(43) Pub. Date: Nov. 5, 2020

(54) ISOLATED SUPPORT PLATFORM

(71) Applicant: EXMARK MANUFACTURING COMPANY, INCORPORATED, Beatrice, NE (US)

(72) Inventors: Christian S.C. Bryant, Lincoln, NE (US); Nickolas T. Moore, Beatrice, NE (US)

(21) Appl. No.: 16/402,938

(22) Filed: May 3, 2019

(51) Int. Cl. A01D 34/69; B62D 51/02; B62D 51/04; A01D 34/00; A01D 34/64; A01D 34/82

(52) U.S. Cl. CPC A01D 34/69; B62D 51/02; B62D 51/04; A01D 2101/00; A01D 34/64; A01D 34/82; A01D 34/001

(57) ABSTRACT

An operator support for a grounds maintenance vehicle, the operator support including a platform, one or more isolator arms, and an isolator element. The platform includes a platform body and a platform arm extending from the platform body. The platform arm is pivotally coupled to a chassis of the grounds maintenance vehicle and configured to pivot about a platform pivot axis. The isolator element is coupled to the chassis of the grounds maintenance vehicle and configured to attenuate vibration transmitted from the chassis to the platform body through the one or more isolator arms. The one or more isolator arms are configured to isolate the platform.

Embodiments of the present disclosure are directed to grounds maintenance vehicles such as stand-on or walk-behind lawn mowers and, more particularly, to such a vehicle incorporating an isolated operator support system.

### BACKGROUND

Riding and walk-behind grounds maintenance vehicles such as lawn mowers and the like are used by homeowners and professionals alike to care for lawns and other surfaces. These vehicles typically include a prime mover, e.g., internal combustion engine or electric motor, to power not only an implement (e.g., cutting deck) attached to the vehicle, but also a traction drive system, the latter adapted to propel the vehicle over a ground surface.

Landscape contractors sometimes prefer stand-on vehicles (e.g., mowers), which include an operator platform that is attached to the vehicle. For example, such mowers allow turf to be mowed in an efficient, relatively quick manner as compared to some conventional riding mowers. One benefit of stand-on and walk-behind maintenance vehicles is that they are often shorter than conventional riding maintenance vehicles and, consequently, may be more maneuverable under certain conditions. Typically, stand-on and walk-behind maintenance vehicles utilize an engine having a horizontally or vertically-oriented drive shaft to provide power, e.g., via endless belts, to both the implement (e.g., cutting deck) and to the traction drive system. Each drive wheel may utilize its own hydrostatic pump, and each pump may be independently controlled to provide the vehicle with a very small turning radius and, in some instances, a zero-turning-radius (ZTR) wherein the vehicle can spin about a midpoint between the two drive wheels.

Stand-on maintenance vehicles often include an operator platform that is movable relative to the vehicle chassis between a stowed position and a deployed position. As such, the operator may stand on the platform when in the deployed position and the operator may stand on the ground surface (and, e.g., walk behind the vehicle) when the platform is in the stowed position. Further, the platform may be in the stowed position when the vehicle is not in use. Additionally, the operator platform may rest upon an isolator when in the deployed position to assist in insulating the user (e.g., standing on the platform) from vibrations and shock loads from the chassis of the vehicle. The isolator may be positioned underneath the platform to provide sufficient contact between the isolator and the platform. As a result, however, the isolator may extend beyond the platform when the platform is in the stowed position such that the isolator protrudes into an area in which the operator may stand when operating the vehicle as a walk-behind maintenance vehicle. Therefore, it may be desirable to maximize the amount of space to accommodate a walk-behind operator while also maintaining durability of the isolation system. Further, due to the direct contact between the isolator and the platform, it may be difficult to adjust the “stiffness” of the platform.

### SUMMARY

Embodiments described herein may provide an operator support for a grounds maintenance vehicle that includes an operator platform that is operably connected to an isolator element without directly contacting the isolator element. For example, the operator support may include a platform, one or more isolator arms, and an isolator element. The platform may include a platform body and a platform arm extending from the platform body. The platform arm may be pivotally coupled to a chassis of the grounds maintenance vehicle and configured to pivot about a platform pivot axis. The isolator element may be coupled to the chassis of the grounds maintenance vehicle and configured to attenuate vibration transmitted from the chassis to the platform body through the one or more isolator arms. The one or more isolator arms may be configured to isolate the platform.

Other embodiments described herein may provide an operator support for a grounds maintenance vehicle. The operator support may include a platform, one or more isolator arms, and an isolator element. The platform may include a platform body and a platform arm extending from the platform body. The platform body may extend between a forward portion and a rear portion. The platform arm may be pivotally coupled to a chassis of the grounds maintenance vehicle and configured to pivot about a platform pivot axis. The one or more isolator arms may extend between a forward portion and a rear portion. The forward portion of the one or more isolator arms may be pivotally coupled to the chassis of the grounds maintenance vehicle and configured to pivot about an isolator arm pivot axis. The platform body may be configured to contact the rear portion of the one or more isolator arms. The isolator element may be coupled to the chassis of the grounds maintenance vehicle and configured to contact the one or more isolator arms between the forward portion of the one or more isolator arms and the rear portion of the one or more isolator arms.

Yet other embodiments described herein may provide a grounds maintenance vehicle including a chassis, a prime mover and an operator support. The chassis may be supported upon a ground surface by a plurality of ground-engaging members. The prime mover may be supported by the chassis. The operator support may include a platform, one or more isolator arms, and an isolator element. The platform may include a platform body and a platform arms extending from the platform body. The platform body may be located aft of the prime mover. The platform arm may be pivotally coupled to the chassis of the grounds maintenance vehicle and configured to pivot about a platform pivot axis. The isolator element may be coupled to the chassis of the grounds maintenance vehicle and configured to attenuate vibration transmitted from the chassis to the platform body through the one or more isolator arms. The one or more isolator arms may be configured to isolate the platform.

The above summary is not intended to describe each embodiment or every implementation. Rather, a more complete understanding of various illustrative embodiments will become apparent and appreciated by reference to the following Detailed Description of Exemplary Embodiments in view of the accompanying figures of the drawing.

### BRIEF DESCRIPTION OF THE VIEWS OF THE DRAWING

Exemplary embodiments will be further described with reference to the figures of the drawing, wherein:

FIG. 1A is a right rear perspective view of a grounds maintenance vehicle, e.g., a stand-on mower, with a platform in a deployed position in accordance with embodiments of the present disclosure;

FIG. 1B is a right rear perspective view of the grounds maintenance vehicle of FIG. 1A with the platform in a stowed position;

FIG. 2 is an enlarged view of an operator support of the grounds maintenance vehicle of FIG. 1A;

FIG. 3 is a right rear perspective view of an isolated platform in accordance with embodiments of the present disclosure;

FIG. 4 is a right rear perspective view of an isolated operator support and associated vehicle structure in accordance with embodiments of the present disclosure;

FIG. 5 is a right side elevation view of the isolated operator support of FIG. 4; and

FIG. 6 is a bottom plan view of the isolated operator support of FIG. 4.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described. The lack of illustration/description of such structure/components in a particular figure is, however, not to be interpreted as limiting the various embodiments in any way.

### DETAILED DESCRIPTION OF ILLUSTRATIVE EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified by the term “about.” The term “and/or” (if used) means one or all of the listed elements or a combination of any two or more of the listed elements. “I.e.” is used as an abbreviation for the Latin phrase id est, and means “that is.” “E.g.,” is used as an abbreviation for Latin phrase exempli gratia, and means “for example.”

Embodiments of the present disclosure are directed to powered (e.g., self-propelled) grounds maintenance vehicles incorporating an operator support that may extend from the rear of the vehicle above the ground surface and configured such that an operator may stand thereon (e.g., when operating the vehicle). The operator support may include a platform that is pivotally coupled to a chassis of the vehicle and may be movable between a stowed position and a deployed position. Further, the operator support may include an isolator element (e.g., an elastomeric isolator) coupled to the chassis and one or more isolator arms extending between the isolator element and the platform. The platform may rest upon the one or more isolator arms when in the deployed position and the isolator element may attenuate vibrations and shocks transmitted from the chassis to the platform (e.g., through the one or more isolator arms). As such, the one or more isolator arms and the isolator element may support the full weight of the platform and, thus, the full weight of an operator standing thereon.

Further, because the one or more isolator arms extend a distance from the isolator element, the one or more isolator arms may form a lever arm (e.g., between the isolator element and the platform) that affects vibration and shock dampening transmitted by the chassis. Therefore, the lever arm may effectively be adjusted to modify the stiffness (e.g., the load/deflection characteristics of the isolation system) felt by an operator located on the platform. Additionally, at least a portion of the isolator element may be positioned forward of the pivot point of the platform such that when the platform is pivoted into the stowed position, the isolator element may not be protruding from the rear of the mower (e.g., into an area in which the operator may walk behind the mower).

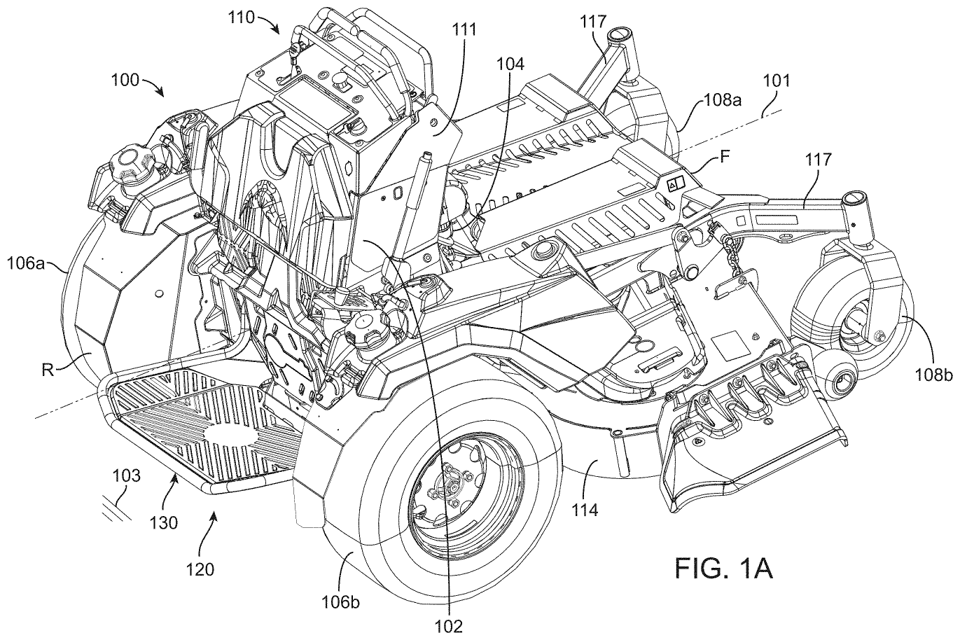

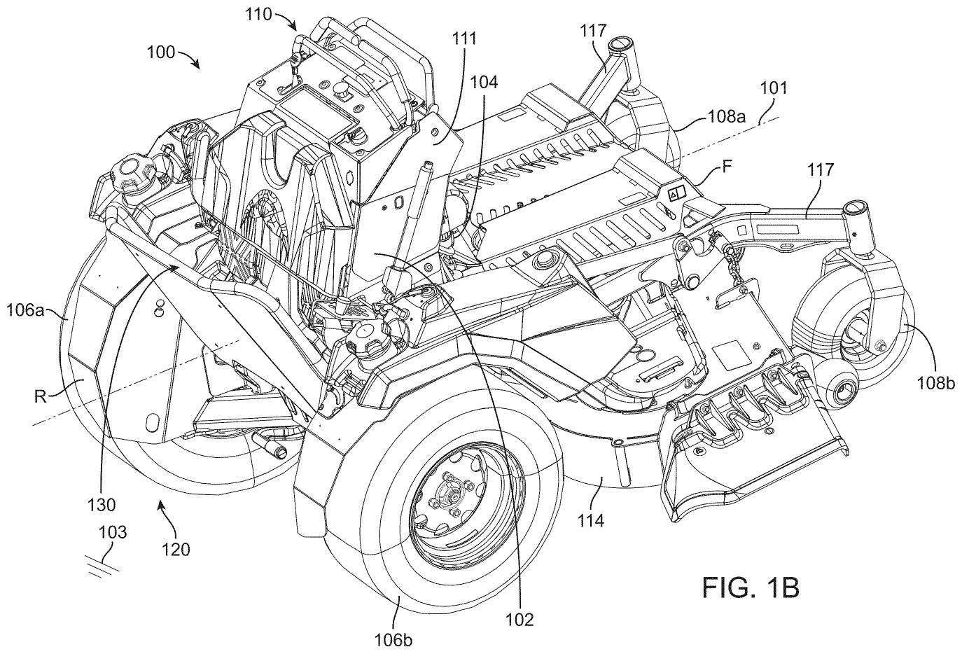

With reference to the figures of the drawing, wherein like reference numerals designate like parts and assemblies throughout the several views, FIGS. 1A and 1B illustrate an operator support 120 in accordance with one embodiment of the present disclosure as it may be incorporated on a self-propelled vehicle, e.g., a mid-mount lawn mower 100. While, for the sake of brevity, embodiments of the disclosure are herein described with reference to a mid-mount stand-on mower (hereinafter generically referred to simply as a “mower”), those of skill in the art will realize that the concepts described herein are equally applicable to other types of walk-behind and stand-on mowers including a platform, as well as to almost any other walk-behind, or stand-on, grounds maintenance vehicle including a platform. Such vehicles may include, for example, skid-steer loaders, aerators, material spreaders and sprayers, snow throwers, tillers, etc.

It is noted that the terms “having,” “including,” “comprises” and variations thereof do not have a limiting meaning where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the mower 100 while the mower 100 is in an operating configuration, e.g., while the mower 100 is positioned such that ground engaging members (e.g., wheels 106 and 108) rest upon a generally horizontal ground surface 103 as shown in FIG. 1A. These terms are used only to simplify the description, however, and not to limit the interpretation of any embodiment described.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

While not necessarily central to an understanding of exemplary embodiments of the present disclosure (e.g., other mower and other vehicle configurations are certainly contemplated), the general construction of the illustrative mower 100 is briefly described below. FIGS. 1A and 1B illustrate the mower 100 including a frame or chassis 102 having a front end F and a rear end R (and a longitudinal axis 101 extending between the front and rear ends), the chassis 102 supporting a power source or prime mover, e.g., internal combustion engine 104 or electric motor. A pair of transversely opposing, ground engaging members, e.g., first and second (left and right) rear drive wheels 106a and 106b, may be coupled to opposite (left and right) rear sides of the chassis to support the mower upon, and propel the mower 100 relative to, the ground surface 103. Each drive wheel 106 may be powered by its own hydraulic motor that receives power from, at least in one embodiment, its own hydrostatic pump. Other drive systems, e.g., gear or pulley driven systems, may also be utilized by the mower 100.

Operator controls, as further described below, permit independent control of the speed and direction of each drive wheel 106, allowing operator control of mower 100 speed and direction from a walking or riding (e.g., standing) position generally behind the mower 100. A pair of front ground engaging members (e.g., left and right caster wheels 108a, 108b), which may be connected to forwardly extending frame rails 117, may support the front of the mower 100 in rolling engagement with the ground surface 103.

Although the illustrated mower 100 has the drive wheels 106 in the rear and caster wheels 108 in front, this configuration is not limiting. For example, other embodiments may reverse the location of the wheels, e.g., drive wheels in front and driven or undriven wheels in back. Moreover, other configurations may use different wheel configurations altogether, e.g., a tri-wheel configuration or a vehicle having conventionally-steered wheels. These and other embodiments are certainly possible without departing from the scope of the present disclosure. Moreover, while illustrated herein as wheels, other ground engaging members (e.g., tracks, skids, etc.) are also contemplated.

An implement, e.g., cutting deck 114, may be connected to a lower side of the chassis 102 (generally longitudinally between the drive wheels 106 and the caster wheels 108). The cutting deck 114 may include one or more cutting blades (not shown) as known in the art. The cutting blades may be operatively powered, via spindles connected to the deck, by the engine 104 via, e.g., an implement drive system. During operation, power may be selectively delivered to the cutting deck 114, whereby the blades rotate at a speed sufficient to sever grass and other vegetation as the cutting deck passes over the ground surface 103. As indicated above, other grounds maintenance vehicles may locate the implement above the chassis, or at other locations along the lower side of the chassis (e.g., a forwardly-mounted or “out-front” deck configuration). Moreover, while described as a cutting deck, the implement may be any tool (e.g., aerator, etc.) that attaches to the chassis 102.

The mower 100 may further include an operator control system 110. In the illustrated embodiment, the control system 110 may include operator controls that are mounted to upwardly extending portions of the chassis referred to herein as control tower 111. The control tower 111 may be located at or near the rear end R of the mower 100. Situated near the top of the control tower is a control area that positions mower controls within comfortable reach of an operator who may be standing either behind the mower or upon a platform 130. The control system 110 may include control levers configured to move the mower 100 forward and rearward. The control system 110 may also include a parking brake handle to selectively activate a brake when the vehicle is parked. A deck height adjustment lever may also be provided to adjust the cutting height of the deck 114. Other controls may include a throttle lever to control the speed of the engine 104, and an implement clutch control to initiate and terminate power delivery to the cutting blades of the mower deck 114.

The illustrative mower 100 may further include an operator support 120 configured to support an operator standing or sitting behind the mower 100 such that the operator is positioned relative to the control system 110 and moves along with the mower 100. The operator support 120 may include a platform 130 (e.g., which may support a standing operator) attached to the chassis 102 at or near the rear end R. In one or more embodiments, the platform 130 may be configured to support a sitting operator (e.g., the platform 130 may include a seat). The platform may be moved between a deployed position as shown in FIG. 1A, and a stowed position as shown in FIG. 1B. In the deployed position, an operator may stand or sit upon the platform 130 (e.g., during vehicle operation). In one or more embodiments, in the deployed position, at least a portion of the operator support 120 may be located between the rear drive wheels 106. Alternatively, the platform 130 may be moved to the stowed position to accommodate the operator in a walk-behind configuration. Further, the mower 100 may be more compact for transport on a trailer and for storage, when the platform 130 is in the stowed position. In one or more embodiments, the platform 130 may be in close proximity or in contact with the control tower 111 when in the stowed position.

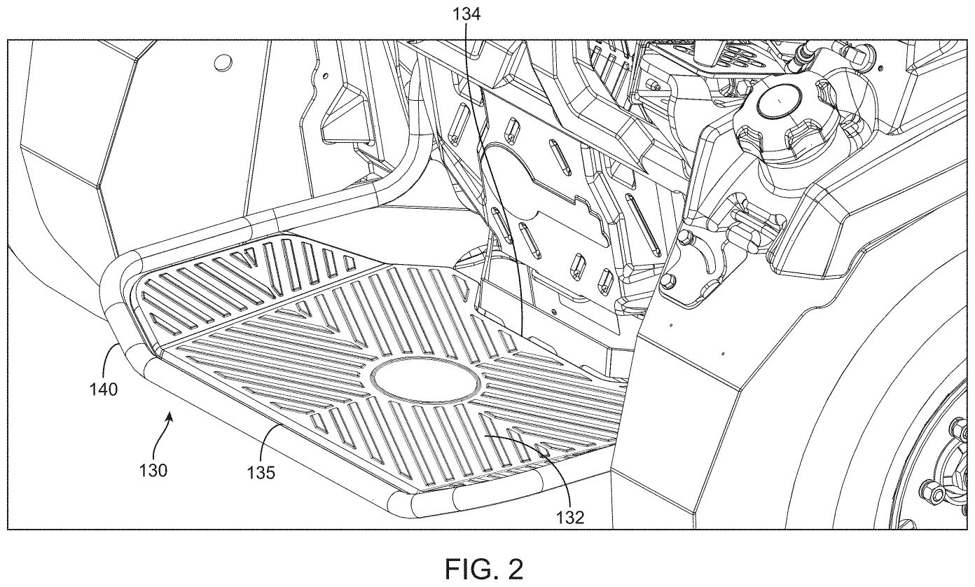

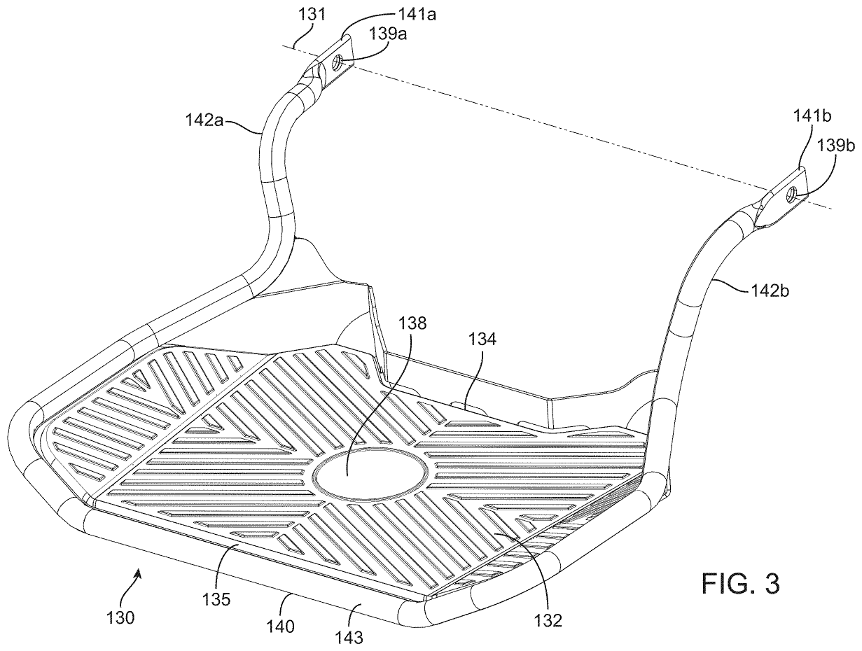

The platform 130 of the operator support 120 is also shown in FIGS. 2 and 3. The platform 130 may include a platform body 132 extending between a forward portion 134 and a rear portion 135 (e.g., in relation to the front end F and the rear end R of the mower 100 when the platform 130 is in the deployed position). The platform body 132 may define a top surface 138 upon which the operator may stand. In one or more embodiments, the top surface 138 of the platform body 132 may include a textured surface to enhance the grip of the operator standing thereon. When the platform 130 is in the deployed position (e.g., as shown in FIG. 1A), the platform body 132 (e.g., the top surface 138) may extend along a generally horizontal or level plane.

The platform 130 may also include a platform arm 140 extending from (e.g., fixedly coupled to) the platform body 132. The platform arm 140 may be pivotally coupled to the chassis 102 of the mower 100 and configured to pivot about a platform pivot axis 131. The platform pivot axis 131 may extend horizontally (e.g., relative to the ground surface 103 when the mower 100 is in an operating position) and perpendicular to a forward direction of motion (e.g., along the longitudinal axis 101) of the mower 100. In other embodiments, the platform arm 140 may be movably coupled to the chassis 102 such that the platform arm 140 moves along a path (e.g., linear, arcuate, etc.) relative to the chassis 102. The platform arm 140 may be coupled to and positioned relative to the platform body 132 in any suitable way such that the platform arm 140 supports the platform body 132 (and, e.g., any weight disposed thereon) above the ground surface 103. In one or more embodiments, the platform arm 140 may define a sufficient length such that, when the operator is standing on the platform 130 and the platform slightly deflects or moves due to vibrations or operating forces, the platform 130 moves in a generally vertical direction. In other words, any slight pivoting movement of the platform 130 may maintain the platform 130 in an approximately level plane (e.g., upon which the operator may stand).

As shown in FIG. 3, the platform arm 140 includes a left portion 142a and a right portion 142b extending from the platform body 132 in a forward direction (e.g., along longitudinal axis 101 towards the front end F as shown in FIG. 1A). In other embodiments, the platform 130 may include a single platform arm extending from the platform body 132 (e.g., centered relative to the platform body 132) and pivotally coupled to the chassis 102. The left and right portions 142a, 142b of the platform arm 140 may extend along the left and right edges (e.g., between the forward and rear portions 134, 135) of the platform body 132, respectively. Each of the left and right portions 142a, 142b may define an end region 141a, 141b in which an aperture 139a, 139b is defined. The platform arm 140 may be pivotally coupled to the chassis 102 through the aperture 139 such that the platform arm 140 (and, e.g., the platform body 132 coupled thereto) pivots about the platform pivot axis 131. For example, U.S. Pat. No. 8,262,104 to Kallevig et al. (which is herein incorporated by reference) describes an operator platform that is positioned at the rear of the vehicle and is pivotally coupled to the chassis.

Further, in one or more embodiments, the platform arm 140 may include a rear portion 143 extending along the rear portion 135 (e.g., the rear edge) of the platform body 132. The rear portion 143 of the platform arm 140 may connect with the left and right portions 142a, 142b. In one or more embodiments, the left portion 142a, the right portion 142b, and the rear portion 143 of the platform arm 140 may form a singular component pivotally coupling the platform body 132 to the chassis 102.

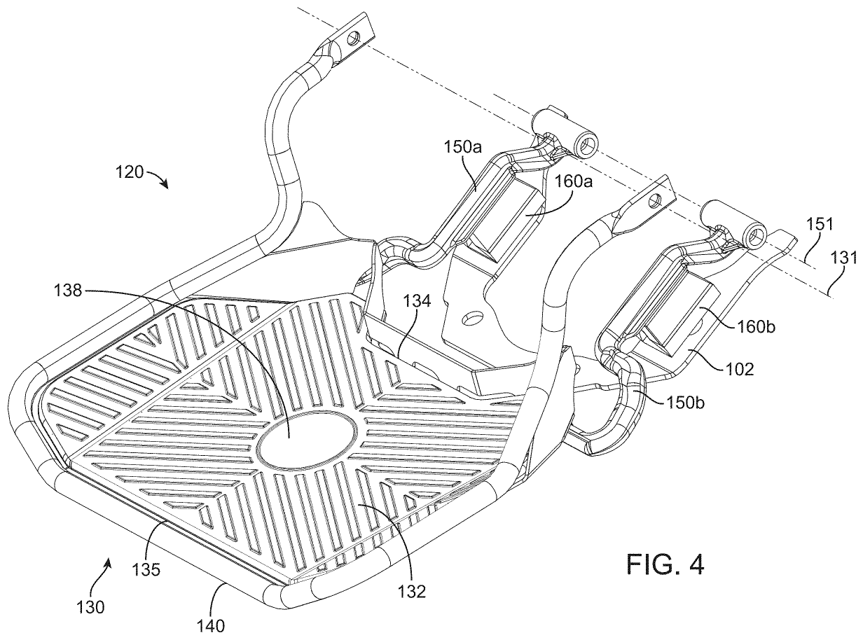

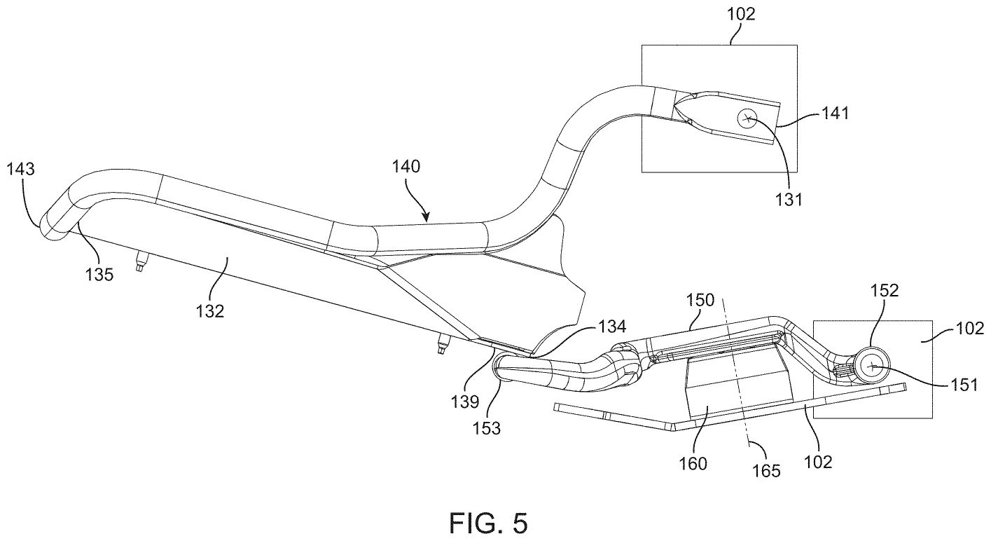

As shown in FIGS. 4 and 5, the operator support 120 may also include an isolator element 160 coupled to the chassis 102 of the mower 100 and configured to attenuate vibration (e.g., from the engine and cutting deck operation) and/or operating forces (e.g., from travel over uneven terrain) transmitted through the chassis 102 to the platform 130. The isolator element 160 may extend along an isolator axis 165 (e.g., a center point) and, in one or more embodiments, the isolator 160 may be coupled to the chassis 102 along the isolator axis 165. In one or more embodiments, the isolator element 160 may include, e.g., an elastomeric isolator, a spring, an air bag, a fluid dampener, etc. The isolator element 160 may by constructed of any suitable material that provides various load/deflection characteristics. For example, in one or more embodiments, an elastomeric isolator may include neoprene (55 Shore A), ethylene propylene diene monomer (M-class) rubber (EPDM, 75-85 Shore A), etc. The isolator element 160 may include any number of isolator elements and may be any shape or size. For example, as shown in FIG. 4, the operator support 120 includes a left isolator element 160a and a right isolator element 160b. In other embodiments, the operator support 120 may include a single isolator element, three isolator elements, four isolator elements, five isolator elements, etc.

Further, the operator support 120 may include one or more isolator arms 150 positioned between the platform 130 and the isolator element 160. As such, the one or more isolator arms 150 may serve as a conduit through which the isolator element 160 may attenuate vibrations and/or operating forces that may otherwise transmit to the platform 130 (e.g., without the platform 130 directly contacting the isolator element 160). However, the one or more isolator arms 150 may not be fixedly coupled to the platform 130 and may not be fixedly coupled to the isolator element 160. In other words, the one or more isolator arms 150 may move relative to both the platform 130 and the isolator element 160. As a result, the one or more isolator arms 150 may be configured to isolate the platform 130 from the isolator elements 160 (e.g., the platform 130 may not directly contact the isolator element 160). In other words, the platform 130 may be spaced apart from the isolator elements 160.

In one or more embodiments, the isolator element 160 may be located forward (e.g., relative to the mower 100) of the entire platform body 132. Therefore, when the platform 130 is moved to the stowed position (e.g., as shown in FIG. 1B), the isolator element 160 may not be exposed. In other words, the isolator element 160 may by not protrude from the rear of the mower 100 such that the isolator element 160 may interfere with an operator walking or standing behind the mower 100.

Further yet, because the one or more isolator arms 150 extend beyond the isolator element 160 and are configured to contact the platform 130 at a distance from the isolator element 160, the one or more isolator arms 150 form a lever arm (e.g., between the platform 130 and the isolator element 160) that may enhance the load/deflection characteristics of the isolator element 160 (e.g., transmitted to the platform 130). For example, the lever arm formed by the one or more isolator arms 150 extending between the isolator element 160 and the platform 130 may provide a lower displacement of the isolator element 160 relative to the displacement of the platform 130 for a given load on the platform 130. In other words, a downward force or load on the platform 130 may produce a displacement of the platform 130 and, due to the position of the isolator element 160 between the platform 130 and the isolator arm pivot axis 151, produce a displacement of the isolator element 160 that is a fraction of the corresponding displacement of the platform 130. Therefore, the isolator element 160 may be able to absorb a larger shock (e.g., operating forces) or vibration transmitted by the platform 130 through the one or more isolator arms 150 (e.g., while also maintaining durability of the isolator element 160 due to the fractional displacement).

Additionally, in one or more embodiments, a force applied to the platform 130 (e.g., the downward force of an operator) may be transmitted to both the platform arm 140 and the one or more isolator arms 150. Therefore, the applied force may be distributed between multiple points (e.g., at the end region 141 of the platform arm 140, at the forward portion 152 of the one or more isolator arms 150) to reduce the load on any one point of connection with the chassis 102. Also, a force applied to the platform 130 (e.g., the downward force of an operator) may be transmitted to the one or more isolator arms 150 and the isolator element 160 (e.g., upon which the one or more isolator arms 150 may rest in the deployed position). Therefore, in one or more embodiments, the one or more isolator arms 150 and the isolator element 160 may support the full weight of the platform 130 and, thus, the full weight of an operator standing thereon (or any other components positioned thereon). Further, a force applied at the one or more isolator arms 150 (e.g., due to a force on the platform 130) multiplied by a distance from the isolator arm pivot axis 151 to the platform 130 may be equivalent to the resultant force on the isolator element 160 multiplied by a distance from the isolator arm pivot axis 151 to the resultant force applied. The distance between the isolator element 160 and the isolator arm pivot axis 151 may be adjustable to customize the attenuation of vibration and operating forces of the platform 130 (e.g., to accommodate various weights on the platform 130 and/or various levels of load/deflection of the isolation system).

The one or more isolator arms 150 may extend between a forward portion 152 and a rear portion 153, as shown in FIG. 5. The forward portion 152 of the one or more isolator arms 150 may be pivotally coupled to the chassis 102 of the mower 100 and configured to pivot about an isolator arm pivot axis 151 (e.g., also shown in FIG. 4). As shown in FIGS. 4 and 5, the isolator arm pivot axis 151 may be different than the platform pivot axis 131. Specifically, the isolator arm pivot axis 151 may be located forward (e.g., relative to the mower 100) of the platform pivot axis 131. In other embodiments, the platform pivot axis 131 may be located forward of the isolator arm pivot axis 151 or the platform pivot axis 131 may be spaced vertically from the isolator arm pivot axis 151 (e.g., relative to the longitudinal axis 101). Further, the platform 130 (e.g., through the platform arm 140) and the one or more isolator arms 150 may be configured to pivot independently from one another. In one or more embodiments, the one or more isolator arms 150 may be movably coupled to the chassis 102 such that the one or more isolator arms 150 move along a path (e.g., linear, arcuate, etc.) relative to the chassis 102. When the platform 130 is in the stowed position (e.g., as shown in FIG. 1B), the platform body 132 may be spaced apart from the one or more isolator arms 150.

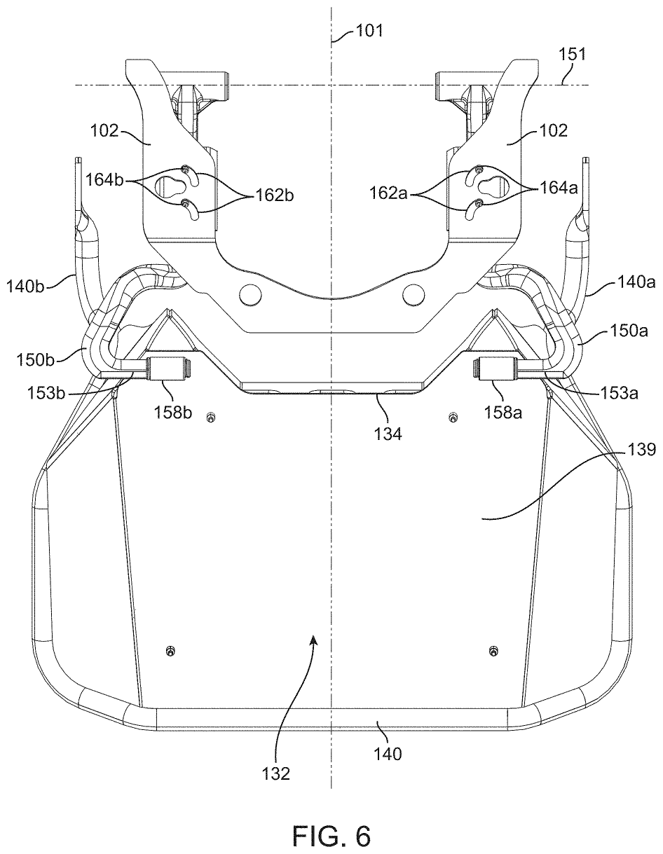

When the platform 130 is in the deployed position (e.g., as shown in FIG. 1A), the platform body 132 (e.g., a bottom surface 139) may be configured to contact the rear portion 153 of the one or more isolator arms 150. For example, the forward portion 134 of the platform body 132 may be configured to contact the rear portion 153 of the one or more isolator arms 150 (e.g., when the platform 130 is in the deployed position). In one or more embodiments, the front edge of the platform body may be configured to contact the rear portion 153 of the one or more isolator arms 150, when in the deployed position. Furthermore, the rear portion 153 of the one or more isolator arms 150 may extend along a direction parallel to the forward portion 134 of the platform body 132 (e.g., as shown in FIG. 6). As such, the one or more isolator arms 150 may be oriented in such a direction (e.g., parallel to the forward portion 134) to minimize the extent to which the one or more isolator arms 150 protrude rearward along the longitudinal axis 101. Therefore, when the platform 130 is in the stowed position, the amount to which the one or more isolator arms 150 protrude into the space directly behind the mower 100 is minimized (e.g., as compared to if the rear portion 153 of the one or more isolator arms 150 extended along the longitudinal axis 101). However, in some embodiments, the rear portion 153 of the one or more isolator arms 150 may extend along the longitudinal axis 101 (e.g., proximate the rear wheels 106a, 106b to be positioned away from the walk-behind area).

The one or more isolator arms 150 may include any suitable number of isolator arms to support the platform 130 and provide a connection between the platform body 132 and the isolator element 160. For example, as shown in FIGS. 4 and 6, the one or more isolator arms 150 may include a left isolator arm 150a and a right isolator arm 150b. The left and right isolator arms 150a, 150b may be configured to be positioned proximate the left and right sides of the platform body 132, respectively (e.g., at the forward portion 134). In other embodiments, the one or more isolator arms 150 may include a single isolator arm. For example, the single isolator arm may be centered relative the platform 130. In one or more embodiments, the number of isolator arms 150 may correspond to the number of isolator elements 160. In other embodiments, the number of isolator arms 150 may be different than the number of isolator elements 160. For example, one or more isolator elements may be configured to contact one or more isolator arms (e.g., a single isolator elements configured to contact multiple isolator arms, two or more isolator elements configured to contact a single isolator arm, two or more isolator elements each configured to contact multiple isolator arms, etc.).

The isolator element 160 may be configured to contact the one or more isolator arms 150 between the forward portion 152 of the one or more isolator arms 150 and the rear portion 153 of the one or more isolator arms 150. Further, the one or more isolator arms 150 may be configured to apply a force to the isolator element 160 in a direction parallel to the isolator axis 165. Due to the one or more isolator arms 150 being positioned to generally apply force along the isolator axis 165 of the isolator element 160, the isolator element 160 may have increased life and durability (e.g., as opposed to applying a force off-center or not parallel to the isolator axis 165).

In one or more embodiments, the isolator element 160 may be configured to be adjusted relative to the chassis 102 and, therefore, relative to the one or more isolator arms 150 (e.g., because the one or more isolator arms 150 may be pivotally coupled to the chassis 102). For example, the isolator element 160 may be configured to be adjusted towards (e.g., closer to) and away (e.g., farther) from the isolator arm pivot axis 151 (e.g., towards the forward portion 152 of the one or more isolator arms 150 and towards the rear portion 153 of the one or more isolator arms 150, respectively). Specifically, the chassis 102 may define one or more slots 162 (e.g., as shown in FIG. 6) within which the isolator element 160 may extend (e.g., one or more protrusions 164 of the isolator element 160 may extend through the slot 162) such that the isolator element 160 may adjust or move along the one or more slots 162. The one or more slots 162 may define any shape that may guide the isolator element 160 to different positions along the longitudinal axis 101. For example, as shown in FIG. 6, the one or more slots 162 define an arcuate shape.

Adjusting the isolator element 160 relative to the chassis 102 (e.g., along the longitudinal axis 101) may also alter the position of the isolator element 160 relative to the one or more isolator arms 150 (e.g., adjusting the isolator element 160 closer to the forward portion 152 or the rear portion 153). As such, the load/deflection characteristics of the operator support 120 may be modified (e.g., by adjusting the position of the isolator element 160) to accommodate the preferences of an operator on the platform 130 (e.g., based on how the isolation system feels to the operator).

In one or more embodiments, the load/deflection characteristics of the isolation system may be adjusted depending on the position of the isolator element 160 relative to the one or more isolator arms 150. For example, for a given operator standing on the platform 130, if the isolator element 160 is positioned near the rear portion 153 of the one or more isolator arms 150, the isolation system may be “stiffer,” providing relatively low deflection for a given input (e.g., operating force and/or vibration). If, on the other hand, the isolator element 160 is positioned more near the forward portion 152 of the one or more isolator arms 150, the isolation system may be more “compliant,” providing greater deflection for the same input and operator. Furthermore, the isolator element 160 may be positioned anywhere therebetween to selectively adjust load/deflection characteristics as desired by the operator.

In one or more embodiments, the operator support 120 may include a friction reducing element 158 positioned between the platform body 132 and the one or more isolators arms 150 (e.g., as shown in FIG. 6). Specifically, the one or more isolator arms 150 may include the friction reducing element 158 located proximate the rear portion 153 of the one or more isolator arms 150. The friction reducing element 158 may be configured to contact the platform body 132 and reduce the friction between the platform body 132 and the one or more isolator arms 150. In one or more embodiments, the friction reducing element 158 may include, e.g., a bushing, a roller, a ball bearing, etc. Further, the friction reducing element 158 may be constructed of any suitable material (e.g., elastomeric material, plastic, steel, etc.). Specifically, the friction reducing element 158 may assist in reducing friction (galling) between the one or more isolator arms 150 and the platform 130 and reducing or eliminating noise associated with direct “metal-on-metal” contact (e.g., between the platform 130 and the one or more isolator arms 150). In one or more embodiments, the friction reducing element 158 may be located on the platform body 132. In some embodiments, the one or more arm isolators 150 may contact the platform body 132 through the friction reducing element 158. In other embodiments, the one or more arm isolators 150 may directly contact the platform body 132 (e.g., without the friction reducing element 158).

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. An operator support for a grounds maintenance vehicle, the operator support comprising:
a platform comprising a platform body and a platform arm extending from the platform body, wherein the platform arm is pivotally coupled to a chassis of the grounds maintenance vehicle and configured to pivot about a platform pivot axis;
one or more isolator arms extending from the chassis of the grounds maintenance vehicle; and
an isolator element coupled to the chassis of the grounds maintenance vehicle and configured to attenuate operating forces transmitted from the chassis to the platform body through the one or more isolator arms, wherein the one or more isolator arms are configured to isolate the platform.

2. The operator support of claim 1, wherein the platform is configurable between a stowed position and a deployed position, wherein the platform body contacts the one or more isolator arms when in the deployed position, and wherein the platform body is spaced apart from the one or more isolator arms when in the stowed position.

3. The operator support of claim 1, wherein the isolator element is located forward of the entire platform body.

4. The operator support of claim 1, wherein the isolator element extends along an isolator axis, wherein the one or more isolator arms are configured to apply a force to the isolator element in a direction parallel to the isolator axis.

5. The operator support of claim 1, wherein the isolator element is configured to be adjusted relative to the one or more isolator arms.

6. The operator support of claim 1, wherein the isolator element moves relative to the chassis within a slot defined by the chassis.

7. The operator support of claim 1, further comprising a friction reducing element positioned between the platform body and the one or more isolator arms.

8. An operator support for a grounds maintenance vehicle, the operator support comprising:
a platform comprising a platform body and a platform arm extending from the platform body, wherein the platform body extends between a forward portion and a rear portion, wherein the platform arm is pivotally coupled to a chassis of the grounds maintenance vehicle and configured to pivot about a platform pivot axis;
one or more isolator arms extending between a forward portion and a rear portion, wherein the forward portion of the one or more isolator arms is pivotally coupled to the chassis of the grounds maintenance vehicle and configured to pivot about an isolator arm pivot axis, and wherein the platform body is configured to contact the rear portion of the one or more isolator arms; and
an isolator element coupled to the chassis of the grounds maintenance vehicle and configured to contact the one or more isolator arms between the forward portion of the one or more isolator arms and the rear portion of the one or more isolator arms.

9. The operator support of claim 8, wherein the platform is configurable between a stowed position and a deployed position, wherein the platform body contacts the one or more isolator arms when in the deployed position, and wherein the platform body is spaced apart from the one or more isolator arms when in the stowed position.

10. The operator support of claim 8, wherein the platform is spaced apart from the isolator element.

11. The operator support of claim 8, wherein the isolator element is located forward of the entire platform body.

12. The operator support of claim 8, wherein the isolator element extends along an isolator axis, wherein the one or more isolator arms are configured to apply a force to the isolator element in a direction parallel to the isolator axis.

13. The operator support of claim 8, wherein the isolator element is configured to be adjusted relative to the one or more isolator arms.

14. The operator support of claim 8, wherein the isolator element moves relative to the chassis within a slot defined by the chassis.

15. The operator support of claim 8, wherein the forward portion of the platform body is configured to contact the rear portion of the one or more isolator arms.

16. The operator support of claim 8, wherein the one or more isolator arms comprises a left isolator arm and a right isolator arm.

17. The operator support of claim 8, wherein the isolator arm pivot axis is located forward of the platform pivot axis.

18. The operator support of claim 8, further comprising a friction reducing element positioned between the platform body and the one or more isolator arms.

19. The operator support of claim 8, wherein the one or more isolator arms comprises a friction reducing element located proximate the rear portion of the one or more isolator arms, wherein the friction reducing element is configured to contact the platform body.

20. A grounds maintenance vehicle comprising:
a chassis supported upon a ground surface by a plurality of ground-engaging members;
a prime mover supported by the chassis; and
an operator support comprising:
a platform comprising a platform body and a platform arm extending from the platform body, wherein the platform body is located aft of the prime mover, wherein the platform arm is pivotally coupled to the chassis of the grounds maintenance vehicle and configured to pivot about a platform pivot axis;
one or more isolator arms extending from the chassis; and
an isolator element coupled to the chassis of the grounds maintenance vehicle and configured to attenuate operating forces transmitted from the chassis to the platform body through the one or more isolator arms, wherein the one or more isolator arms are configured to isolate the platform.
